(19) United States
(12) Patent Application Publication
(10) Pub. No.: US 2014/0158920 A1
(43) Pub. Date: Jun. 12, 2014

(54) DIGITAL PROXIMITY SENSOR

(71) Applicant: MASCO CORPORATION, Taylor, MI (US)

(72) Inventors: Jeffrey John Belz, Sterling Heights, MI (US); Paul McLennan, London (CA)

(73) Assignee: MASCO CORPORATION, Taylor, MI (US)

(21) Appl. No.: 13/708,947

(22) Filed: Dec. 8, 2012

(51) Int. Cl. F16K 31/02

(52) U.S. Cl. CPC F16K 31/02
USPC 251/129.01

(57) ABSTRACT

An automated plumbing fixture includes a position sensing device. The position sensing device includes a control module including a controller and a digital input connection, a capacitive position sensor module isolated from said control module, wherein said capacitive position sensor module includes a digital output, and a digital communication cable connecting said digital output to said digital input.

### BACKGROUND OF THE INVENTION

The present disclosure is related generally to position sensing devices, and more specifically to a position sensing device for an automatic plumbing fixture.

Position sensing automated devices, such as automatic faucets or drinking fountains, utilize position sensors built into the structure of the faucet to determine the position of a user relative to the metal fixture of the faucet. When the user is closer than a certain distance, the faucet activates and begins dispensing water. Similar arrangements are also utilized in drinking fountains and other plumbing fixtures.

A common type of position sensing device used in these arrangements is a capacitive based sensor. The capacitive based sensor detects a capacitance between the metal fixture of the faucet and the person approaching or leaving the fixture. The strength of the capacitance varies depending on the distance between the person and the fixture according to known principles. In this way, a capacitance probe contacting the fixture can sense the capacitance and a controller can determine the position of the person based on this capacitance.

### SUMMARY OF THE INVENTION

Disclosed is an automated plumbing fixture including a position sensing device. The position sensing device includes a control module including a controller and a digital input connection, a capacitive position sensor module isolated from said control module, wherein said capacitive position sensor module includes a digital output, and a digital communication cable connecting said digital output to said digital input.

These and other features may be best understood from the following drawings and specification.

### BRIEF DESCRIPTION OF THE DRAWINGS

FIG. 1 is a schematic illustration of an automated faucet arrangement.

FIG. 2 is a schematic illustration of a sensor module for use with the automatic faucet arrangement of FIG. 1.

FIG. 3 is a schematic illustration of a control fixture for use with the automated faucet arrangement of FIG. 1.

### DETAILED DESCRIPTION

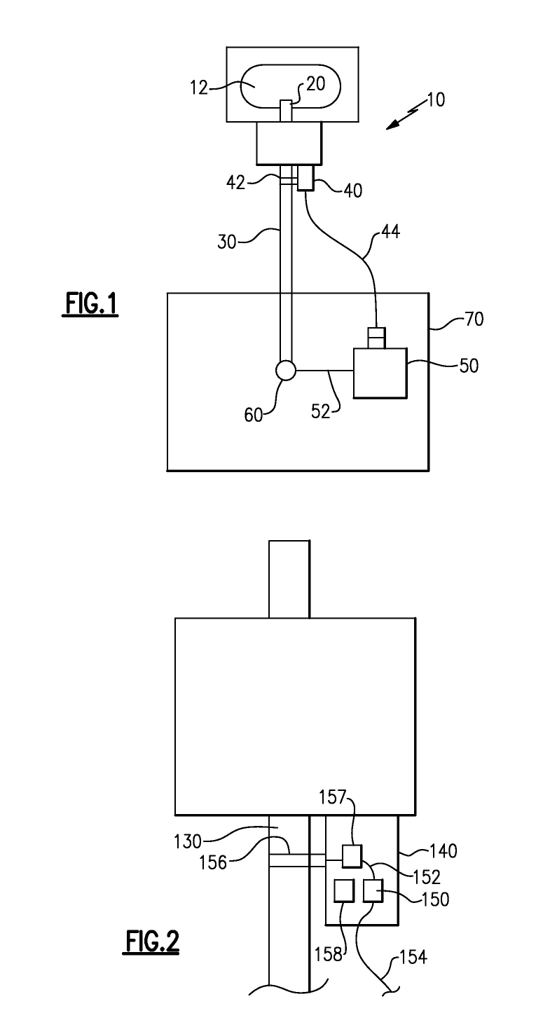

FIG. 1 illustrates a highly schematic automatic faucet arrangement 10. The faucet arrangement 10 includes a faucet 20 for distributing water into a sink 12. The faucet 20 is connected to a faucet pipe 30 that is, in turn, connected to a water supply such as a water main. Also included in the faucet assembly 20 is a sensor module 40 having a probe 42 for detecting a capacitance of the faucet 20 and a digital output wire 44 for transmitting the sensed capacitance value to a controller 50. The controller 50 is located remote from the sensor module 40 in an enclosure 70. Also contained in the enclosure 70 is a control valve 60. The control valve 60 is controlled using a control signal from the controller 50 on a control wire 52.

Existing position sensing devices use an analog sensor wire placed along the faucet pipe 30 to sense the capacitance between a user and the faucet pipe 30 and faucet 20 arrangement. The analogue sensor wire is connected directly to the controller and provides the capacitance input. Because the communication wire is also the sensor wire (alternately referred to as a sensor probe), care is taken to ensure that the sensor wire contacts only the faucet pipe 30 and does not contact other conductive objects that would skew the sensor reading. Furthermore, the sensor wire must maintain contact with the faucet pipe 30 along a length of the faucet pipe 30, and thus the sensor wire is not shielded. If the sensor wire contacts conductive objects aside from the faucet pipe 30, the measurements of the capacitance probe become inaccurate. As a result, the controller of existing position sensor devices cannot be located within certain conductive housing types, such as a metal housing, or utilize conductive conduits to route the sensor wire.

In the example of FIG. 1, the sensor module 40 includes a capacitive sensor that measures a capacitance between the faucet pipe 30 and a person approaching the faucet pipe 20 using a capacitance probe 42. As the faucet pipe 30 and the faucet 20 are connected and are electrically conductive, the probe 42 senses the overall capacitance between the faucet 20 and the faucet pipe 30 arrangement and a user when the probe is connected to the faucet pipe 30 and provides the sensed value to a sensor module probe input.

The capacitance of the faucet 20 and the faucet pipe 30 arrangement depends on a distance between the faucet 20 and a person approaching the faucet 20. In particular, the approaching person forms one-half of a capacitor and the faucet 20 and the faucet pipe 30 arrangement forms the other half of the capacitor. The distance between the person and the faucet 20 is the dielectric gap of the formed capacitor. The capacitance of the formed capacitor is related to the distance between the person and the faucet according to known principles. By determining the capacitance, the controller can use these principles to determine the distance of the dielectric gap, and therefore, the distance between the user and the faucet 20.

The sensor module 40 converts the measured capacitance value to a digital form using an on-board processor and outputs the digital value through the digital communication wire 44 to the controller 50. In some examples, multiple capacitance sensors are included in each sensor module 40. In such an example, the controller 50 receives multiple digital capacitance values and uses an algorithm within the controller 50 to determine the actual distance.

Once the controller 50 receives the capacitance values from the sensor modules 40, and determines the distance between the person and the faucet 20, the controller 50 outputs a valve control signal along a control signal wire 52 connecting the controller 50 to the valve 60. The controller 50 is a programmable controller including a processor and a rewriteable memory and controls multiple different functions of the automatic faucet arrangement 10 based on the received capacitance values from the sensor module 40. While the example of FIG. 1 includes a single valve 60, it is understood that more complicated flow control systems can be utilized and controlled in a similar manner using the above described scheme.

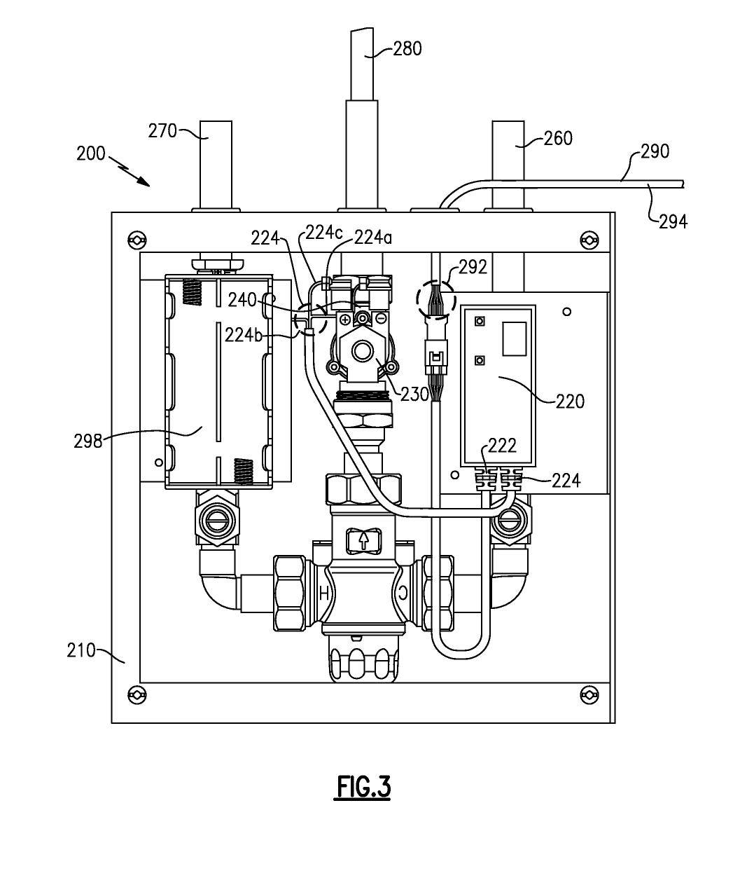

FIG. 2 schematically illustrates a sensor module 140 that can be used in the embodiment of FIG. 1 in greater detail. The sensor module 140 includes a processor 150 and a memory 158. A capacitance probe input 152 of the processor 150 is connected to a capacitance probe 156. The capacitance probe 156 is connected to a faucet shank 130 at a single point, thereby minimizing the chances of inadvertent electric contact altering the measured capacitance and skewing the position sensing.

The capacitance probe 156 and the capacitance sensor 157 determine an analogue capacitance value of the capacitor formed between the user and the faucet 20, and pass the analogue capacitance value to the processor 150. The processor 150 converts the analogue capacitance value to a digital capacitance value and transmits the digital capacitance value to the controller 50 (see FIG. 1). The memory 158 of the sensor module 140 can store simple instructions for the processor 150, thereby enabling the processor 150 to perform conversions and other functions on the determined capacitance value prior to transmitting the value to the controller 50. Alternatively, the memory 158 can be used to store/buffer multiple capacitance values to be sent to the controller 50 in packets.

In an alternate example, the processor 150 within the sensor module 140 can perform all the tasks associated with measuring and processing the detected capacitance values from the position sensor resulting in a digital distance value determined at the sensor module 140. Once the processor 150 has processed the values, the sensor module 140 outputs the digital distance value across the digital output line 154 to the remote controller. The remote controller then controls the flow of the faucet depending upon the determined distance value, rather than a measured capacitance value.

By utilizing a sensor module 140 including a processor 150, the sensor module 140 can be isolated from the controller 50 and perform simple processing on the measured values. The processor 150 further allows the sensor module 140 to be compactly located at the faucet 20 preventing inadvertent contact between the sensor probe and other conductive elements as a result of running a sensor wire to the controller 50. Utilization of a digital communication wire 154 connecting the sensor module 140 and the controller 50, instead of the analog sensor wire of existing position sensing devices, allows the controller 50 to be placed within a fixture using shielded walls, such as metal plumbing fixtures or similar enclosures, without impacting performance of the position sensing device.

FIG. 3 schematically illustrates an example control fixture 200. The control fixture 200 includes a conductive metal housing 210 containing a controller 220. The controller 220 includes a digital input 222 that receives a digital signal from the remote position sensor module 140 illustrated in FIG. 2. The controller 220 includes a memory, a processor, and a user input mechanism that allows a controller 220 to be programmed by an installer. The digital input 222 can be a bundle of digital input signals 292 as shown, or a single digital input. The digital input 222 is a shielded digital communication line and is routed to the controller in a conduit. In some examples the conduit is constructed of metal or another conductive substance.

The controller 220 also includes an output bundle 224 that contains multiple output signals 224A/224C each of which has a dedicated output wire within the bundle 224. Each output wire 224A/224C controls a separate component within the fixture 200. Control wire 224A provides a control signal that controls a flow control valve 230, and control wire 224C provides a solenoid control signal to a solenoid 240. Similarly, the controller 220 can control any known flow control devices within a fixture 200 using known flow control techniques. Bundled with the control wires 224A/224C is a power supply wire 224B that connects a power supply 298 to the controller 220.

As described above, the controller 220 receives a digital value representing the distance between the user and the faucet, and determines an action to perform in response. In the illustrated example, the controller 220 operates the solenoid 240 and opens the flow control valve 230 when the user is within a set distance threshold, thereby turning on the faucet. When the user exits the threshold distance, the controller 220 turns off the faucet by reversing the control commands. The controller 220 can be programmed with any desired response to a distance measurement, and the programming is stored in the controller's re-writable memory.

While the above description relates to an automatic faucet arrangement, it is understood that similar arrangements using a remote sensor module and a controller within a plumbing fixture can be utilized in any plumbing arrangement and still fall within this disclosure.

Although an embodiment of this invention has been disclosed, a worker of ordinary skill in this art would recognize that certain modifications would come within the scope of this invention. For that reason, the following claims should be studied to determine the true scope and content of this invention.

1. An automated plumbing fixture comprising:
a pipe:
a position sensing device including:
a control module including a controller and a digital input connection;
a capacitive position sensor module isolated from said control module, wherein said capacitive position sensor module includes a digital output and a capacitance probe contacting the pipe at a single point; and
a digital communication cable connecting said digital output to said digital input.

2. The automated plumbing fixture of claim 1, wherein said control module is contained within a conductive housing, and wherein said capacitive position sensor module is remote from said conductive housing.

3. The automated plumbing fixture of claim 2, wherein said housing is metal.

4. The automated plumbing fixture of claim 1, wherein said digital communication cable is contained within a conductive conduit.

5. The automated plumbing fixture of claim 1, wherein said capacitive position sensor module comprises a processor operable to process a detected capacitance.

6. The automated plumbing fixture of claim 5, wherein said processor includes a memory storing instructions operable to cause said processor to determine a capacitance value based on sensed values.

7. The automated plumbing fixture of claim 6, wherein said memory further stores instructions operable to cause said processor to determine a distance between a user and said position sensing device based on said capacitance value.

8. The automated plumbing fixture of claim 1, wherein said controller is a programmable controller and includes a rewritable memory.

9. The automated plumbing fixture of claim 8, wherein said rewritable memory includes instructions operable to cause said controller to control at least one of a valve control, a solenoid, and a range determination in response to a detected distance value from said sensor module.

10. The automated plumbing fixture of claim 1, wherein a capacitance value detected by said capacitive position sensor module is an analog capacitance value.

11. The automated plumbing fixture of claim 1, wherein the digital communication cable and the capacitive probe are distinct components.

12. The automated plumbing fixture of claim 1, wherein the capacitive position sensor module is defined by an absence of a sensor wire.
